(19) United States
(12) Patent Application Publication
(10) Pub. No.: US 2026/0034007 A1
(43) Pub. Date: Feb. 5, 2026

(54) Curling grasping member and method

(71) Applicant: DME INNOVATIONS, INC., San Diego, CA (US)

(72) Inventors: Anton K. Simson, Truckee, CA (US); Todd A. Simson, San Diego, CA (US)

(73) Assignee: DME INNOVATIONS, INC., San Diego, CA (US)

(21) Appl. No.: 18/998,063

(22) PCT Filed: Jul. 27, 2023
(86) PCT No.: PCT/US2023/028809

§ 371 Date: Jan. 23, 2025

Related U.S. Application Data
(60) Provisional application No. 63/392,841, filed on Jul. 27, 2022.

(51) Int. Cl. A61G 7/10; B25J 9/10; B25J 15/12

(52) U.S. Cl. CPC A61G 7/1076; A61G 7/1015; B25J 9/104; B25J 15/12

(57) ABSTRACT

A curling grasping member for use in a non-ambulatory patient lifting apparatus. The grasping member can have a base unit (11) including a number of spaced apart generally wedge-shaped segments (33) that extend from transversal fins (30) connected to a flexible bottom backing panel (20). A tensioning cable running through the segments can drive the curling of the member. In its curled configuration, adjacent segments can contact one another to prevent further curling. The bottom backing panel can have a varying thickness or other features which control the flexibility of the grasping member and thus which longitudinal regions curl more acutely to begin with. The base unit including the bottom panel, fins and segments can be injection molded as a unitary piece in a simple clamshell mold.

### PRIOR APPLICATION

This application claims the benefit of U.S. Provisional Patent Application Ser. No. 63/392,841, filed 2022 Jul. 27, incorporated herein by reference.

### FIELD OF THE INVENTION

The invention relates to automated mechanical lifting devices, and more specifically to devices for lifting a non-ambulatory patient.

### BACKGROUND

Many devices have been proposed for lifting non-ambulatory medical patients so as to avoid the necessity having a number of strong and skilled persons at the ready. An automated patient lifting apparatus is described in Simson, U.S. Pat. No. 10,238,565 (hereinafter “Simson”) and shown in Simson, U.S. Pat. No. D879302, both of which are incorporated herein by reference. As shown in FIG. 1 this patient lift 1 can include a support frame 2 which supports a number of grasping members 3,4,5,6 that extend from the support frame. Each removable grasping member can mount to a dedicated port 7 on the frame allowing defective grasping members to be swapped out for servicing or replacement. As shown in FIG. 2, each grasping member can be driven to curl inwardly to reach beneath and curl around a body to be lifted. The curling can be driven by motors internal to the frame and/or manually using handles 8.

As further disclosed in Simson, in the context of a sitting patient such as a paraplegic person for example, the members can extend underneath the thigh regions and behind the patient's torso in order to grasp them. Because each member can curl rather than merely translate as non-curling pincers, the width of the device can remain substantially constant during its operation, greatly improving the usefulness of the device in the narrow confines of a personal living space.

Simson further provides that the members can transition from a substantially flat, open configuration as shown in FIG. 1 to the curled, arcuate configuration shown in FIG. 2 in a smoothly continuous manner. Each member can use trapezoidal segments mounted to a flexible back or outside panel. This panel can act as a hinged connection between the segments. The hinged movement between all the segments can occur simultaneously along the longitudinal dimension of the member, thereby achieving the smoothly continuous curling.

Simson further provides that a curvable top or inside panel can be used to drive the curling of the grasping member. Alternately, a cable operating similarly to a flexor tendon of a finger can be used to curl the grasping member. The resiliency of the back panel can spring the grasping member back into its flattened configuration when the tension on the cable is released.

Unfortunately, the grasping members described in Simson can be relatively complex requiring skillful and precise manufacturing and assembly of a diverse number of separately molded parts which can lead to increased manufacturing costs. Further, mechanical strain on the back panel is increased in those locations between where the segments join to the back panel, requiring the panel to be stronger and less flexible. Repetitive dynamic loads placed on the members could lead to rapid wear on the back panel and many other interconnected parts. Thus, frequent repair or replacement of the parts can be anticipated during the life of the lifting apparatus which can significantly increase the costs of operation.

Therefore, there is a need for a curling grasping panel which addresses some or all of the above identified inadequacies.

### SUMMARY

The principal and secondary objects of the invention are to provide an improved curling grasping member for lifting devices. These and other objects are achieved by an interchangeable grasping member including spaced apart fins.

In some embodiments there is provided a grasping member device for use in a lifting apparatus, said device comprises: a flexible bottom panel extending longitudinally from a proximal end to a distal end; a plurality of fins extending upwardly from said flexible bottom panel; wherein said fins are longitudinally spaced apart; a first series of spaced-apart segments connected to said fins; wherein a first segment is a first one of said spaced-apart segments, a second segment is a second one of said spaced-apart segments, a first fin is a first one of said fins, and a second fin is a second one of said fins; wherein said first segment extends longitudinally from said first fin apart from said flexible bottom panel; said first segment supporting a first bearing surface; wherein said second segment extends longitudinally from said second fin; said second segment supporting a second bearing surface; wherein said first and second bearing surfaces are separated from one another by a first longitudinal distance while said grasping member is in an uncurled configuration; wherein said first and second bearing surfaces are separated from one another by a second longitudinal distance while said grasping member is in an arcuate configuration; and, wherein said second longitudinal distance is smaller than said first longitudinal distance.

In some embodiments said second longitudinal distance is zero, whereby said first and second bearing faces contact one another while said grasping member is in an arcuate configuration.

In some embodiments said first segment further comprises: a longitudinal undercut between said first bearing surface and said flexible bottom panel.

In some embodiments said first segment further comprises: a forwardly extending prominence supporting said first bearing surface; a rearwardly extending prominence supporting an aft bearing surface; a fore longitudinal undercut between said first bearing surface and said flexible bottom panel; and, an aft longitudinal undercut between said aft bearing surface and said flexible bottom panel.

In some embodiments said second segment extends longitudinally from said second fin apart from said flexible bottom panel.

In some embodiments said first segment extends laterally a distance beyond a lateral edge of said flexible bottom panel.

In some embodiments the device further comprises: a plurality of spaced apart nibs extending laterally from said lateral edge; wherein each of said nibs supports one of said segments at a fulcrum.

In some embodiments the device further comprises: a flexible cover panel slidingly contacting each of said fins along a top surface of each of said fins.

In some embodiments the device further comprises a resilient pad supported by a top surface of said flexible cover panel.

In some embodiments the device further comprises a resilient pad secured atop said fins.

In some embodiments said resilient pad comprises: a plurality of longitudinally spaced apart crenellation extending between said fins.

In some embodiments the device further comprises: a curling mechanism rotating said fins with respect to one another.

In some embodiments said curling mechanism comprises a flexible cable extending longitudinally along said member.

In some embodiments the device further comprises: each of said segments having an arcuate top edge; wherein a curvature of said arcuate top edge is selected to match a curvature of said member while said grasping member is in an arcuate configuration.

In some embodiments the device further comprises: each of said segments comprising a longitudinal arcuate channel along said arcuate top edge; wherein said channel is dimensioned to allow passage of said cable therethrough.

In some embodiments said cable comprises: a loop comprising: a first arm extending longitudinally along a first lateral side of said member; a second arm extending longitudinally along a second lateral side of said member; a fastener connecting said first arm to said second arm; and, wherein said fastener adjusts a separation between said first arm and said second arm.

In some embodiments said fastener comprises a turnbuckle.

In some embodiments the device further comprises: said panel having a variable thickness between said proximal end and said distal end; and, wherein said variable thickness tapers substantially linearly between a first thickness and a second thickness.

In some embodiments the device further comprises: said panel having a variable thickness between said proximal end and said distal end; and, wherein said variable thickness provides progressively diminishing discrete thicknesses between successive pairs of said fins.

In some embodiments the device further comprises: said fins having progressively diminishing heights from said proximal end to said distal end.

In some embodiments there is provided a device for use in a lifting apparatus, said device comprises: a flexible bottom panel extending longitudinally from a proximal end to a distal end; said flexible bottom panel extending latitudinally between lateral edges; at least one fin extending upwardly from said flexible bottom panel, and extending latitudinally between said lateral edges; a first segment attached to a first end of said fin; and, wherein said first segment comprises a prominence extending longitudinally from said first fin apart from said flexible bottom panel.

In some embodiments said first segment further comprises: a prominence projecting longitudinally beyond the longitudinal extent of said fin to form a longitudinal undercut between said prominence and said flexible bottom panel.

In some embodiments said first segment extends latitudinally beyond a latitudinal extent of said lateral edge adjacent to said fin.

In some embodiments there is provided a method for manufacturing a curling grasping member for a lift apparatus, said method comprises: selecting a grasping member structure that curls within a longitudinal plane; further selecting said grasping member structure to have a base unit made from a unitary piece of material; wherein said base unit comprises: a solid flexible bottom panel having a top surface; a first fin extending upwardly from said top surface; a second fin extending upwardly from said top surface; said first and second fins being longitudinally spaced apart; a first pair of segments joined to opposite lateral ends of said first fin; a second pair of segments joined to opposite lateral ends of said second fin; injection molding said base unit via a clamshell mold; installing a curling mechanism in said base unit; and, securing a flexible cover made from a resilient material to said base unit.

The original text of the original claims is incorporated herein by reference as describing features in some embodiments.

### BRIEF DESCRIPTION OF THE DRAWING

FIG. 1 is a prior art diagrammatical perspective view of a patient lift having detachable curling grasping members in their uncurled configuration.

FIG. 2 is a prior art diagrammatical perspective view of the patient lift of FIG. 1 having curling grasping members in their curled configuration.

FIG. 3 is a diagrammatical top, front, left side perspective view of a base unit of a curling grasping member according to an exemplary embodiment of the invention.

FIG. 4 is a diagrammatical bottom, back, right side perspective view of the base unit of FIG. 3.

FIG. 5 is a diagrammatical enlarged partial perspective view of the base unit of FIG. 3 taken at circle 5-5.

FIG. 6 is a diagrammatical enlarged partial perspective view of the base unit of FIG. 4 taken at circle 6-6.

FIG. 7 is a diagrammatical right side elevational view of the base unit with tensioning cable installed.

FIG. 8 is a diagrammatical partial top view thereof.

FIG. 9 is a diagrammatical cross-sectional end view of the base unit of FIG. 8 taken at line 9-9.

FIG. 10 is a diagrammatical partial cross-sectional side view of the grasping member in its uncurled and curled configuration.

FIG. 11 is a diagrammatical partial cross-sectional side view of a grasping member having a resilient pad having a crenellated undersurface.

FIG. 12 is a diagrammatical partial cross-sectional side view of an adjacent pair of segments extending from a variable thickness backing panel.

FIG. 13 is a diagrammatical partial cross-sectional side view of a series of segments straddling portions of a backing panel having discrete diminishing thicknesses.

FIG. 14 is a flow chart diagram of a method for manufacturing a grasping member according to an exemplary embodiment of the invention.

### DESCRIPTION OF THE PREFERRED EMBODIMENTS

In this specification, the references to top, bottom, upward, downward, upper, lower, vertical, horizontal, sideways, lateral, back, front, proximal, distal, etc. can be used to provide a clear frame of reference for the various structures with respect to other structures usually as oriented in the drawing being referred to. These references should not be treated as absolutes when the frame of reference is changed, such as when the device is inverted, shown on its side, or disassembled.

If used in this specification, the term “substantially” can be used with respect to manufacturing imprecision and inaccuracies that can lead to non-symmetricity and other inexactitudes in the shape, dimensioning, orientation, and positioning of various structures. Further, use of “substantially” in connection with certain geometrical shapes and orientations, such as “parallel” and “perpendicular”, can be given as a guide to generally describe the function of various structures, and to allow for slight departures from exact mathematical geometrical shapes, such as cylinders, disks and cones, and their orientations, while providing adequately similar function. Those skilled in the art will readily appreciate the degree to which a departure can be made from the mathematically exact geometrical references.

If used in this specification, the word “axial” is meant to refer to directions, movement, or forces acting substantially parallel with or along a respective axis, and not to refer to rotational nor radial nor angular directions, movement or forces, nor torsional forces.

In this specification the units “millimeter” or “millimeters” can be abbreviated “mm”, “centimeter” or “centimeters” can be abbreviated “cm”.

In this specification reference may be made to the use of numerous patches or layers of hook-and-vane fabric fastener such as VELCRO brand fastener available from Velcro USA Inc. of Manchester, New Hampshire in which a patch of hook-and-vane fabric fastener of a first type (either hook or vane) can releasably fasten to a patch of the opposite type. For example a patch of the hook type would releasably bond to a patch of the vane type or some other common, loosely woven fabrics. For clarity such fasteners are referred to in this specification as fabric fasteners, and a patch of fabric fastener will bond to a corresponding patch of fabric fastener. Those skilled in the art will readily appreciate which type will best be used for any given patch and whether the type of matable patches can be swapped.

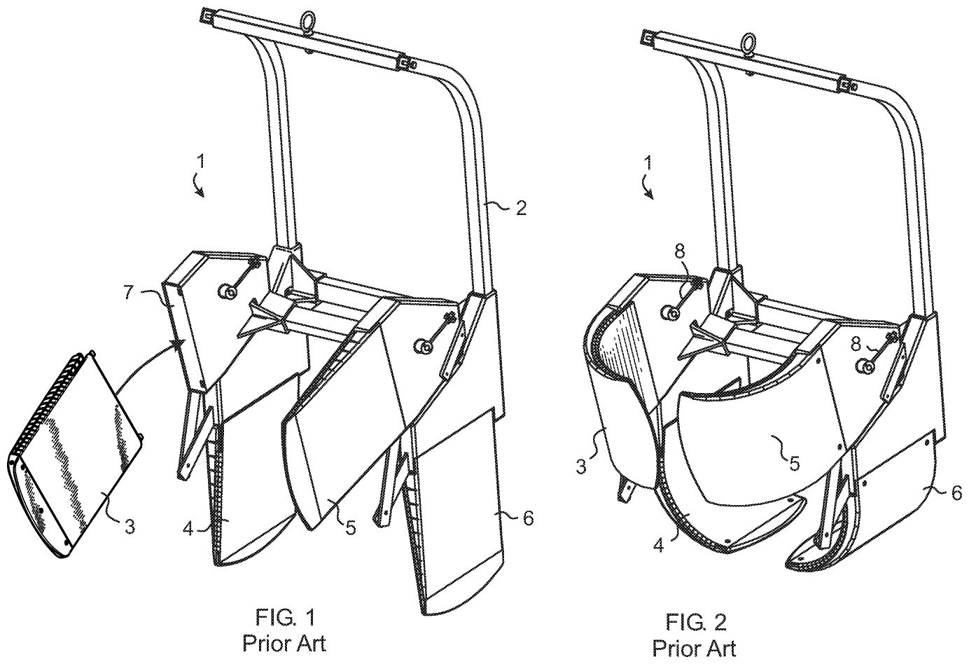

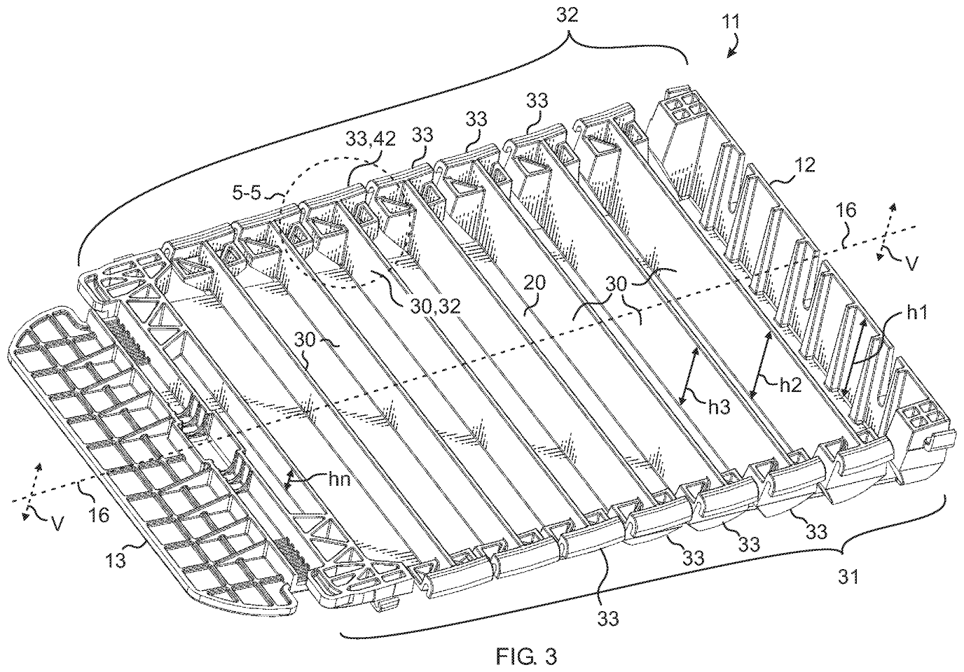

Referring now to the drawing, there is shown in FIGS. 3-7 a base unit 11 of a grasping member according to an exemplary embodiment of the invention shown in its flattened, uncurled, open configuration. The base unit can be manufactured from a unitary piece of durable, injection molded, solid material such as a durable, strong industrial plastic such as polypropylene or polyethylene. The base unit can be substantially symmetrical with respect to a longitudinal plane extending in the vertical direction indicated by arrows V and extending along a central longitudinal axis 16. The base unit can have a proximal end 12 for connecting to a port on a patient lift apparatus similar to the one shown in FIG. 1, and a longitudinally opposite distal end 13 for forming the tip of the grasping member.

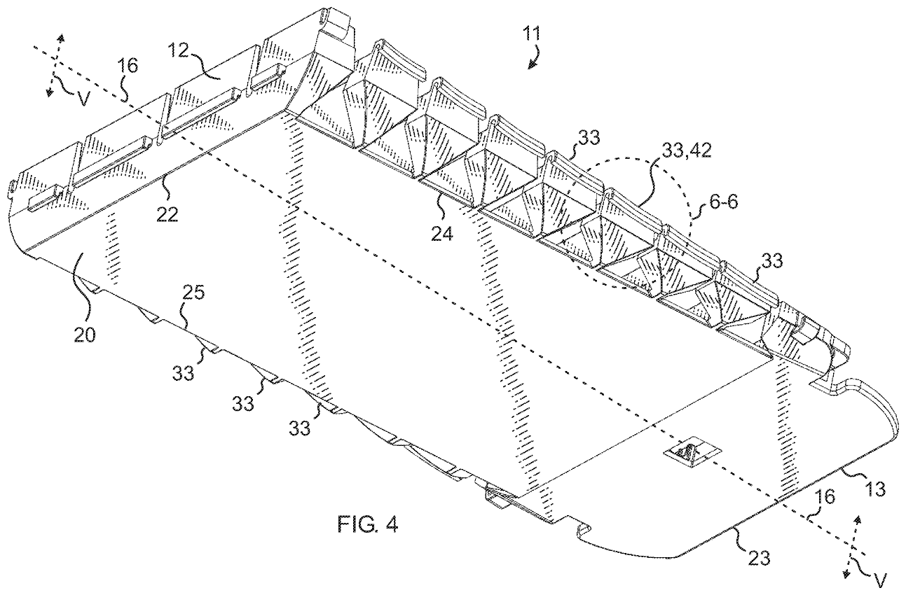

As shown primarily in FIGS. 3-4, the base unit 11, and hence the grasping member, can include a bottom backing panel 20 can be a substantially planar sheet in the uncurled configuration as shown. The bottom panel can be roughly quadrangular having a proximal edge 22, an opposite distal edge 23, and a pair of lateral side edges 24, 25.

As shown primarily in FIG. 3, a series of longitudinally spaced apart, laterally transversing, stiffening fins 30 can extend upwardly from a top surface of the bottom panel and span the lateral dimension of the bottom panel. The fins can have progressively diminishing vertical heights h1, h2, h3 . . . hn as they proceed toward the distal end 13 of the base unit.

Two series 31,32 of substantially pentangular, substantially home plate-shaped, rotation limiting segments 33 can extend from the opposite lateral ends of the fins 30. In other words, each fin can have a dedicated pair of laterally spaced apart segments symmetrical about the central vertical longitudinal plane. The combination of a fin and its dedicated pair of segments can be referred to as a cantle unit.

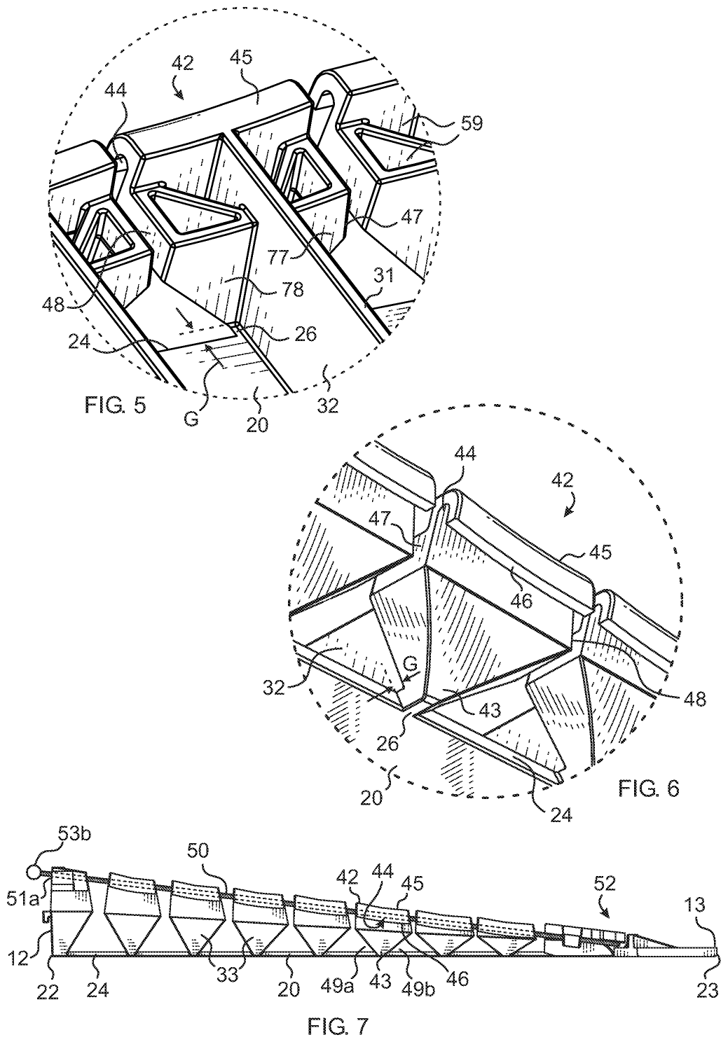

As shown more clearly in FIGS. 5-7, each individual segment 42 can have a lower wedge-shaped portion that tapers downwardly to form a fulcrum 43 thereby creating a pair of longitudinal undercuts 49a,49b straddling the front and back edges of the lower wedge-shaped portion. The fulcrum can join with a nib 26 extending laterally beyond the respective edge 24 of the bottom panel 20. In this way the segment can extend laterally apart for the bottom panel. A gap G can be formed between the laterally innermost part of the segment and the edge of the bottom panel to ensure flexibility of the panel. The respective fin 32 can join with the nib and segment to strengthen the nib and segment interface. In this way the area of contact between the bottom panel and the fins can be minimized in order to enhance the longitudinal flexibility of the bottom panel. In other words, apart from where the fins contact the upper surface of the bottom panel, the entire bottom panel can freely bend during curling within the vertical plane while still exhibiting enhanced lateral stiffness.

Each segment 42 can also have an upper portion having and arcuate concave top edge 45, and a pair of longitudinally projecting prominences 77,78 that support bearing surfaces 47,48 each oriented to securely and ruggedly contact the bearing surface on an adjacent segment when that part of the base unit reaches its fully curled configuration, thus limiting any further rotation of a cantle unit with respect to an adjacent cantle unit. A first prominence 77 can project rearwardly, and a second prominence 78 can project forwardly.

The lateral thickness of each segment 42 lends itself to the removal of material to save on weight and reduce waste. Hollows 59 can be formed into the segments resulting in various walls and gusset structures to maintain strength and stiffness.

It shall be noted, as shown in FIGS. 3 and 5, that the height of a portion of the top edge 45 of each segment 42 can be commensurate with the height of the top edge 31 of the fin 32 to which it is attached. In this way, the top surfaces of the base unit 11 of the grasping member can smoothly slide beneath the undersurface of a top cover and/or pad to the base unit which will be described further below.

Referring primarily to FIG. 7, the curling of the base unit 11 of the grasping member can be driven by a curling mechanism which can include a tensioning member in the form of a cable 50 extending longitudinally from an outlet 51b in the proximal end 12 to an anchor 52 near the distal end 13. The cable can be made from wound strands of stainless steel or other strong flexible materials. Tension can be applied to the cable by a motor or crank located in the lifting apparatus which pulls on a terminal end cap 53b formed on the free end of the cable. It shall be noted that the cable can also provide a means for carrying the load on the grasping member provided by the body being lifted.

A medial portion of the cable 50 can run through a longitudinal inverted U-shaped channel 44 formed by a curved lip 46 near the arcuate top edge 45 of each segment 42. The channels of each series of segments are aligned to form a guide path for the cable.

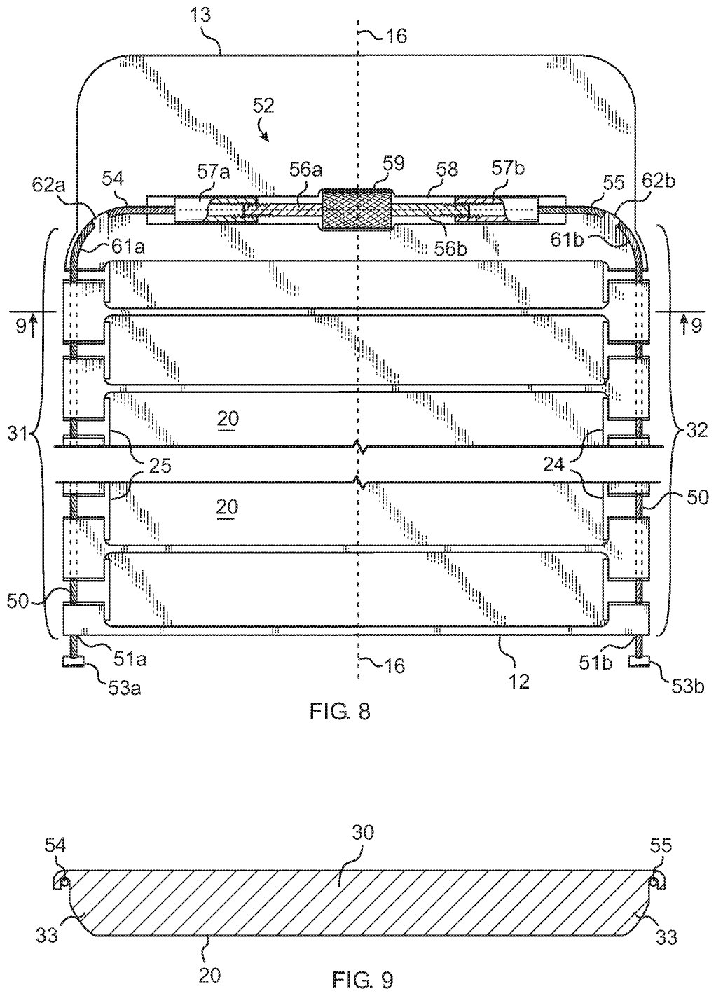

As shown primarily in FIG. 8, the cable can be formed by a pair of cable arms 54,55 connected to form a loop in which one arm 54 can run through the first series 40 of segments along one side 25 of the bottom panel 20 while the other arm 55 can run through the second series 41 of segments along the opposite side 24. Both cable arms can be joined at their distal ends by a turnbuckle connector forming the anchor 52 having pair of alternately threaded coaxial posts 56a,56b that engage threaded bores in a pair of cable arm endpieces 57a,57b slidingly mounted within a pocket 58 molded into the base unit distally from or integrated with the most distal cantle unit. The turnbuckle can have a knurled central drum 59 to facilitate hand manipulation during adjustment. Adjustment of the turnbuckle while the grasping member is in its open, uncurled configuration allows for adjustment in the length of the cable arms to compensate for tensioning inaccuracies. This can adjust the resting tension on the cables and help prevent back-curling of the grasping member if it encounters unforseen forces as it engages a body of a patient. A pair of substantially circularly curved cable tracks 61a,61b facilitates smooth adjustment of the tension along the lengths of the cable arms. A pair tabs 62a,62b can project laterally and forwardly from the top edges of the tracks to help prevent the cable arms from inadvertently dislodging from the tracks. The proximal ends of each cable arm can extend through corresponding outlets 51a,51b and terminate in terminal end caps 53a,53b.

During curling, as tension on the cable arms 54,55 increases, the most distal segment begins to lift upwardly. The cable can then act against the channels of each of the segments to successively pull the most distal segment pair to rotate as the back panel bends. As the cable tension increases, it causes the sequential or simultaneous rotation of cantle units progressively from the distal end toward the proximal end. In this way the cable acts as a tensioning member which hales a series of segments together.

As shown, the entire base unit of FIGS. 1-9, apart from the curling mechanism cabling, can be molded in its open flattened configuration without structures superimposed over one another. Consequently, those skilled in injection mold manufacturing will appreciate that in this way the entire base unit of the grasping member can be injection molded using a simple clam shell mold. The base unit thus can combine all the required structure, flexibility, and load paths required of a fully functional, detachable and replaceable grasping member into a single injection molded part made of flexible plastic. The total part count for the base unit can be one.

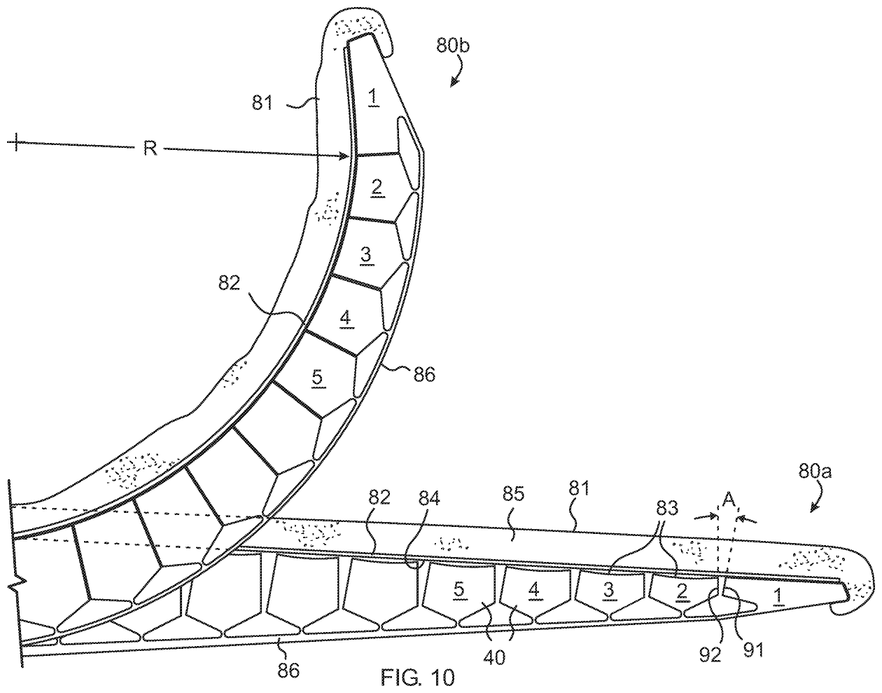

FIG. 10 shows a partial side view of a grasping member in both its open, flattened configuration 80a and in its closed, curled configuration 80b where the last five segments are numbered consecutively from 1 to 5 beginning with the last, most distal segment. The grasping member can include a flexible cover 81 on its top, inner side secured to a bottom base unit 86. The cover can readily be secured to the base unit through a snap fitting or through fabric fasteners for example. The cover can include a flexible cover panel 82 made from a substantially planar, substantially quadrangular piece of durable, flexible, substantially non-compressible, solid sheet material such as a strong industrial plastic such as polypropylene or polyethylene. The top surfaces 83 of the fins and segments of the base unit, and bottom surface 84 of the cover panel 82 can be smooth so that they may freely slide against one another during curling. A pad 85 made of resiliently compressible foam material can be bonded to the top surface of the cover panel to enhance the comfort of patients being lifted. Alternately, the flexible cover panel can be secured separately to the base unit and a protective pad made of resiliently compressible foam material can be fitted over the combined base unit and cover panel. In addition, for sanitary reasons, the entire grasping member can readily be inserted into a disposable or washable form-fitting sleeve made from fabric, plastic or other flexible sheet material.

FIG. 10 further shows that corresponding bearing surfaces 91,92 of adjacent segments 1,2 can be angled at an angle A with respect to one another when the base unit is in its open, flattened configuration 80a. The angle can be selected so that the base unit in its curled configuration provides a desired radius of curvature R. The radius can be common to all segments or selected to be different for each pair of segments, resulting in a base unit having a variable radius of curvature across the segments. In this way, successively adjacent segments 1-5 can form a smoothly curving grasping member in the curled configuration 80b.

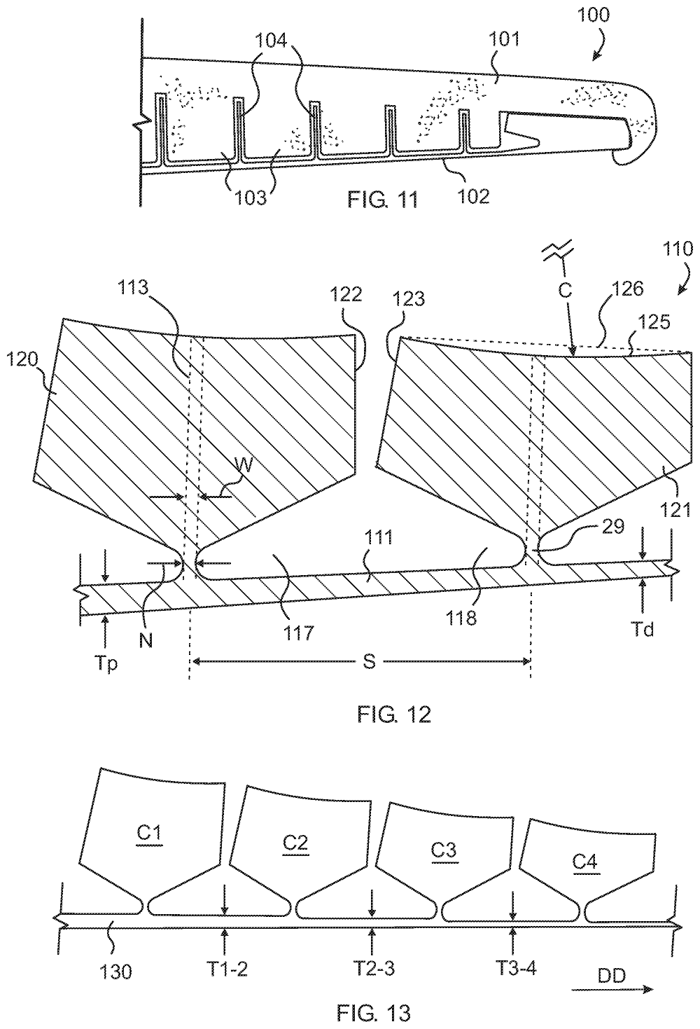

FIG. 11 shows an alternate embodiment of a grasping member 100 where the cover 101 is mounted to a base unit 102. The cover can be made from flexible compressible material such as plastic foam. An undersurface of the cover is formed to have a number of longitudinally spaced apart crenellations 103 which extend into the longitudinal gaps between adjacent fins 104. The crenellations become compressed when the base unit achieves its curled configuration and are thus frictionally retained by contact with the fins preventing unwanted separation of the cover from medial sections of the base unit.

FIG. 12 shows an alternate embodiment of the base unit 110 that allows further control of the sequential rotation of the fin and segment pair cantle units with respect to one another. The bottom panel 111 can have a thickness that tapers from a first thickness Tp near the proximal end 12 toward a second thickness Td near the distal end 13 where Tp is thicker than Td. For example, Tp can be selected to have a thickness of 0.125 inch, whereas Td can have a thickness of 0.06 inch, where the thickness tapers substantially linearly between the two.

FIG. 12 also shows more clearly some of the features found in earlier embodiments, namely, that the width W of a fin 113 can be commensurate with the longitudinal thickness of the fulcrum 114 at its narrowest point N, and the longitudinal undercuts 117,118 between adjacent segments 120,121 longitudinally spaced apart by a spacing S can support adjacent angled bearing surfaces 122,123. This embodiment also more clearly shows that the top edge 125 of a segment 121 can have concave cross-section having a radius of curvature C that provides a smooth transition of the curvature to adjacent segments and allowing the base unit to have a substantially smooth and continuous concave inner surface when in the curled configuration. A flat cross-section 126 is shown in dotted line for comparison.

Alternately, as shown in FIG. 13, the thickness of the bottom panel 130 can progressively decrease in discrete steps between successive portions of the bottom panel between the fins. For example, the bottom panel between cantle unit C1 and C2 can have a uniform thickness T1-2. Between cantle unit C2 and C3 the bottom panel can have a uniform thickness T2-3. And, between cantle unit C3 and C4 the bottom panel can have a uniform thickness T3-4. The thicknesses can progressively reduce in size in the distal direction DD.

The dimensions of the grasping member can be readily scaled to the size of the lifting apparatus and the intended weight limits the apparatus will be subjected to. In the embodiment of FIG. 3 the grasping member can have a longitudinal length of approximately 12 inches (30 cm) and the width of approximately 10 inches (25 cm). The overall vertical thickness of the proximal end can be approximately 1.5 inches (4 cm). Thes above dimensions are intended to accommodate patients weighing up to about 500 pounds (225 kgs).

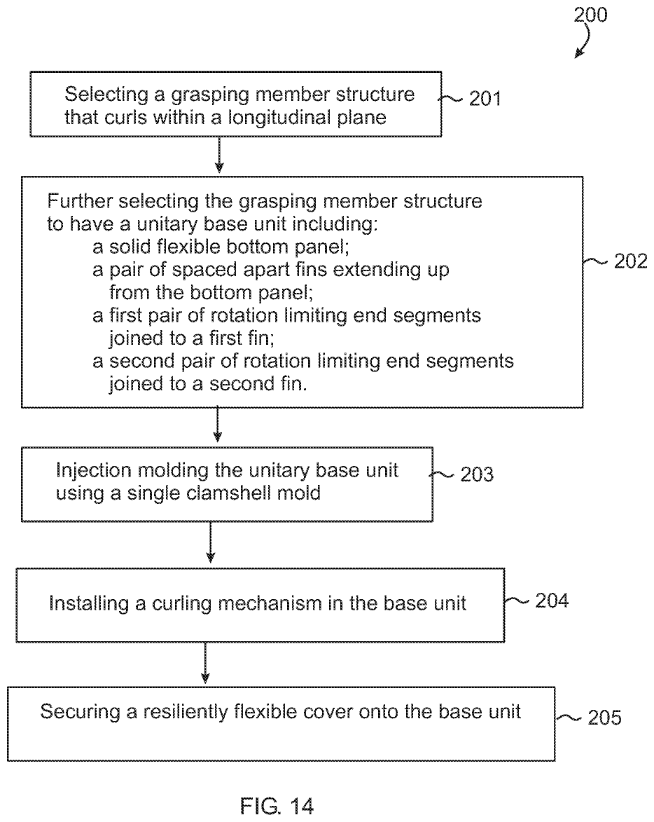

Referring now to FIG. 14, there is shown an exemplary embodiment of a method 200 for manufacturing a curling grasping member for a lift apparatus. The method can include selecting 201 a grasping member structure that curls within a longitudinal plane, and further selecting 202 the grasping member to include a base unit made from a unitary piece of material such as injection molded plastic. The base unit can include a solid flexible bottom panel, at least one pair of spaced apart fins extending upwardly from the top surface, and a pair of rotation limiting segments joined to the lateral ends of each fin. The base unit can be injection molded 203 using a single simple clamshell mold. Once the base unit has been molded a curling mechanism such as the cabling shown in FIG. 8 can be installed 204. Thereafter a flexible cover such as the cover shown in FIG. 11 can be secured 205 to the base unit.

While the exemplary embodiments of the invention have been described, modifications can be made and other embodiments may be devised without departing from the spirit of the invention and the scope of the appended claims.

What is claimed is:

1. A grasping member device for use in a lifting apparatus, said device comprises:
a flexible bottom panel extending longitudinally from a proximal end to a distal end;
a plurality of fins extending upwardly from said flexible bottom panel;
wherein said fins are longitudinally spaced apart;
a first series of spaced-apart segments connected to said fins;
wherein a first segment is a first one of said spaced-apart segments, a second segment is a second one of said spaced-apart segments, a first fin is a first one of said fins, and a second fin is a second one of said fins;
wherein said first segment extends longitudinally from said first fin apart from said flexible bottom panel;
said first segment supporting a first bearing surface;
wherein said second segment extends longitudinally from said second fin;
said second segment supporting a second bearing surface;
wherein said first and second bearing surfaces are separated from one another by a first longitudinal distance while said grasping member is in an uncurled configuration;
wherein said first and second bearing surfaces are separated from one another by a second longitudinal distance while said grasping member is in an arcuate configuration; and,
wherein said second longitudinal distance is smaller than said first longitudinal distance.

2. The device of claim 1, wherein said second longitudinal distance is zero, whereby said first and second bearing faces contact one another while said grasping member is in an arcuate configuration.

3. The device of claim 1, wherein said first segment further comprises:
a longitudinal undercut between said first bearing surface and said flexible bottom panel.

4. The device of claim 1, wherein said first segment further comprises:
a forwardly extending prominence supporting said first bearing surface;
a rearwardly extending prominence supporting an aft bearing surface;
a fore longitudinal undercut between said first bearing surface and said flexible bottom panel; and,
an aft longitudinal undercut between said aft bearing surface and said flexible bottom panel.

5. The device of claim 1, wherein said second segment extends longitudinally from said second fin apart from said flexible bottom panel.

6. The device of claim 1, wherein said first segment extends laterally a distance beyond a lateral edge of said flexible bottom panel.

7. The device of claim 6, which further comprises:
a plurality of spaced apart nibs extending laterally from said lateral edge;
wherein each of said nibs supports one of said segments at a fulcrum.

9. The device of claim 1, which further comprises:
a flexible cover panel slidingly contacting each of said fins along a top surface of each of said fins.

10. The device of claim 9, which further comprises a resilient pad supported by a top surface of said flexible cover panel.

11. The device of claim 1, which further comprises a resilient pad secured atop said fins.

12. The device of claim 11, wherein said resilient pad comprises:
a plurality of longitudinally spaced apart crenellation extending between said fins.

13. The device of claim 1, which further comprises:
a curling mechanism rotating said fins with respect to one another.

14. The device of claim 13, wherein said curling mechanism comprises a flexible cable extending longitudinally along said member.

15. The device of claim 14, which further comprises:
each of said segments having an arcuate top edge;
wherein a curvature of said arcuate top edge is selected to match a curvature of said member while said grasping member is in an arcuate configuration.

16. The device of claim 15, which further comprises:
each of said segments comprising a longitudinal arcuate channel along said arcuate top edge; wherein said channel is dimensioned to allow passage of said cable therethrough.

17. The device of claim 14, wherein said cable comprises:
a loop comprising:
a first arm extending longitudinally along a first lateral side of said member;
a second arm extending longitudinally along a second lateral side of said member;
a fastener connecting said first arm to said second arm; and,
wherein said fastener adjusts a separation between said first arm and said second arm.

18. The device of claim 17, wherein said fastener comprises a turnbuckle.

19. The device of claim 1, which further comprises:
said panel having a variable thickness between said proximal end and said distal end; and,
wherein said variable thickness tapers substantially linearly between a first thickness and a second thickness.

20. The device of claim 1, which further comprises:
said panel having a variable thickness between said proximal end and said distal end; and,
wherein said variable thickness provides progressively diminishing discrete thicknesses between successive pairs of said fins.

21. The device of claim 1, which further comprises:
said fins having progressively diminishing heights from said proximal end to said distal end.

22. A device for use in a lifting apparatus, said device comprises:
a flexible bottom panel extending longitudinally from a proximal end to a distal end;
said flexible bottom panel extending latitudinally between lateral edges;
at least one fin extending upwardly from said flexible bottom panel, and extending latitudinally between said lateral edges;
a first segment attached to a first end of said fin; and,
wherein said first segment comprises a prominence extending longitudinally from said first fin apart from said flexible bottom panel.

23. The device of claim 22, wherein said first segment further comprises:
a prominence projecting longitudinally beyond the longitudinal extent of said fin to form a longitudinal undercut between said prominence and said flexible bottom panel.

24. The device of claim 22, wherein said first segment extends latitudinally beyond a latitudinal extent of said lateral edge adjacent to said fin.

25. A method for manufacturing a curling grasping member for a lift apparatus, said method comprises:
selecting a grasping member structure that curls within a longitudinal plane;
further selecting said grasping member structure to have a base unit made from a unitary piece of material;
wherein said base unit comprises:
a solid flexible bottom panel having a top surface;
a first fin extending upwardly from said top surface;
a second fin extending upwardly from said top surface;
said first and second fins being longitudinally spaced apart;
a first pair of segments joined to opposite lateral ends of said first fin;
a second pair of segments joined to opposite lateral ends of said second fin;
injection molding said base unit via a clamshell mold;
installing a curling mechanism in said base unit; and,
securing a flexible cover made from a resilient material to said base unit.
